(19) United States
(12) Patent Application Publication
(10) Pub. No.: US 2024/0367190 A1
(43) Pub. Date: Nov. 7, 2024

(54) Single-material All-plastic Lotion Pump

(71) Applicant: Guangzhou Shanggong Plastic Co.,Lid, Guangzhou (CN)

(72) Inventor: Qi Quan LIANG, Guangzhou (CN)

(21) Appl. No.: 17/914,789

(22) PCT Filed: May 13, 2022
(86) PCT No.: PCT/CN22/92784

§ 371 Date: Sep. 27, 2022

(51) Int. Cl. B05B 11/10

(52) U.S. Cl. CPC B05B 11/1047; B05B 11/1035; B05B 11/1069; B05B 11/1077

(57) ABSTRACT

Disclosed is a single-material all-plastic lotion pump, including a main body, a pressing head, a barrel body, a one-way liquid outlet mechanism and a tubular spring; a guide hole communicates the inside of the main body from two opposite ports thereof; the press head is in an inserted connection with one port of the main body in a pressable manner, and is provided with a liquid outlet channel; the barrel body is in an inserted connection with the other port of the main body, and has a liquid inlet channel in a bottom wall; the one-way liquid outlet mechanism passes through the guide hole, and has an import channel and an export channel; and the tubular spring is compressed between the one-way liquid outlet mechanism and the bottom wall of the barrel body, and is connected and communicated with the import and liquid inlet channels at both ends, respectively.

### TECHNICAL FIELD

The present disclosure herein relates to the technical field of lotion pump heads, in particular to a single-material all-plastic lotion pump.

### BACKGROUND

In the prior art, a lotion pump needs to be composed of a plurality of components. The materials of all the component are different. Some of the components are made of soft rubber, some of the components are made of hard rubber, and some of the components are made of metal. Therefore, during recycling, the lotion pump needs to be disassembled and classified to realize the classification and recovery of the different materials, which not only causes a higher recovery cost, but also is difficult in recovery, and for this reason, a technical solution that can solve the problem is urgently needed.

### SUMMARY

It is an object of the present disclosure to provide a single-material all-plastic lotion pump to solve the problem that the existing lotion pumps are difficult to classify and recycle.

In order to solve the problem, the present disclosure provides a single-material all-plastic lotion pump, including a main body, a pressing head, a barrel body, a one-way liquid outlet mechanism and a tubular spring which are made of the same plastic material; the inside of the main body is provided with a guide hole communicating through two opposite ports of the main body; the press head is in an inserted connection with one port of the main body in a pressable manner, and is provided with a liquid outlet channel; the barrel body is in an inserted connection with the other port of the main body, the guide hole is externally surrounded by the barrel body, and a bottom wall of the barrel body is provided with a liquid inlet channel; the one-way liquid outlet mechanism passes through the guide hole, and is provided with an import channel and an export channel, and the export channel is connected and communicated with the liquid outlet channel; the one-way liquid outlet mechanism is used to communicate the import channel and the export channel when the pressing head is pressed; and the tubular spring is compressed between the one-way liquid outlet mechanism and the bottom wall of the barrel body, one end of the tubular spring is connected and communicated with the import channel, and the other end thereof is connected and communicated with the liquid inlet channel.

In one embodiment, the single-material all-plastic lotion pump is made of polyethylene.

In one embodiment, the one-way liquid outlet mechanism includes a connecting rod and a piston unit; the connecting rod passes through the guide hole, and is internally provided with the export channel running through both ends of the connecting rod; and the piston unit is slidably installed in the barrel body, the piston unit is connected to the connecting rod, and the import channel is provided on the piston unit.

In one embodiment, an air vent is reserved in a peripheral wall, adjacent to the guide hole, of the barrel body, and is communicated with the inside of the barrel body; the piston unit includes an air return piston and a liquid inlet piston; the air return piston is slidably installed in the barrel body, and is provided with an air plug through hole communicating itself; the liquid inlet piston is slidably installed between the air return piston and the tubular spring, and the liquid inlet piston is in a sleeved connection with the tubular spring; the liquid inlet piston is provided with liquid plug through holes communicating itself, and the plurality of liquid plug through holes are all communicated with the inside of the tubular spring; and the connecting rod is connected and fixed with the liquid inlet piston through the air plug through hole, the connecting rod, the air return piston and the liquid inlet piston are linked by a linkage structure, the air return piston and the liquid inlet piston are controlled to be separated from and abutted against each other by the movement of the connecting rod, and the separation between the air return piston and the liquid inlet piston is used to form the import channel.

In one embodiment, the air return piston is provided with a circle of guide wall around a peripheral side of the air plug through hole; the liquid inlet piston is provided with a fixing groove, and the plurality of liquid plug through holes are provided around a peripheral side of the fixing groove; an ejector rod, guide ribs and a circle of limiting wall are disposed at one end, placed in the barrel body, of the connecting rod; the ejector rod is separately disposed opposite to a port of the export channel, the ejector rod is inserted into the fixing groove through the air plug through hole, and the ejector rod is connected and fixed with the fixing groove; the plurality of guide ribs are separately disposed around a peripheral side of the ejector rod, and are all connected between a peripheral edge of the port of the export channel and a peripheral wall of the ejector rod; and peripheral sides of the plurality of guide ribs are externally surrounded by the limiting wall, a limiting slot is defined by the limiting wall and the plurality of guide ribs, and the guide wall is inserted into the limiting slot.

In one embodiment, the main body is internally provided with a pressing cavity and a bottling cavity, and the pressing cavity and the bottling cavity are disposed separately and are allowed to be communicated with each other by the guide hole; the pressing cavity is in an inserted connection with the pressing head; and the bottling cavity is in an inserted connection with the barrel body, an inner peripheral wall of the bottling cavity is separated from an outer peripheral wall of the barrel body, and the inner peripheral wall of the bottling cavity is provided with internal threads.

In one embodiment, an outer peripheral edge, facing a port of the guide hole, of the barrel body is provided with a circle of flange, which is abutted against a cavity bottom of the bottling cavity; and the single-material all-plastic lotion pump further includes a gasket, and the gasket is sleeved outside the barrel body and is abutted against with the flange.

In one embodiment, the tubular spring is provided with a one-way valve, and the one-way valve covers the liquid inlet channel and is used to control the liquid inlet channel to feed liquid into the tubular spring in a one-way manner.

In one embodiment, the one-way valve includes connecting ribs and an elastic membrane; one ends of the plurality of connecting ribs are all connected with an inner peripheral wall of the tubular spring, and the other ends thereof are all connected with a peripheral edge of the elastic membrane; and the elastic membrane covers the liquid inlet channel, and is used to deform under a force so as to release the covering to the liquid inlet channel.

In one embodiment, the single-material all-plastic lotion pump further includes a suction tube, and the suction tube is disposed outside the barrel body and is communicated with the liquid inlet channel.

The present disclosure has the beneficial effects that:

Since the present disclosure includes the main body, the pressing head, the barrel body, the one-way liquid outlet mechanism and the tubular spring which are made of the same plastic material, the entire lotion pump is made of the same material, and material classification is not required during recycling, which greatly reduces recycling difficulty and recycling cost, and further effectively solves the problem of difficulty in classifying and recycling the existing lotion pumps.

### BRIEF DESCRIPTION OF FIGURES

In order to illustrate the technical solutions of the present disclosure more clearly, the following will briefly introduce the accompanying drawings used in the implementations. The drawings in the following description are only some implementations of the present disclosure, and it will be apparent to those skilled in the art, other drawings can also be obtained based on these drawings without any creative work.

FIG. 1 is a schematic diagram of a section view structure of a lotion pump provided by the embodiment of the present disclosure;

FIG. 2 is a schematic diagram of the section view structure of FIG. 1 in an application state;

FIG. 3 is a schematic diagram of an exploded structure of FIG. 2;

FIG. 4 is a schematic diagram of a section view structure of a main body of FIG. 1;

FIG. 5 is a schematic diagram of a section view structure of a pressing head of FIG. 1;

FIG. 6 is a schematic diagram of a section view structure of a barrel body of FIG. 1;

FIG. 7 is a schematic diagram of a section view structure of a one-way liquid outlet mechanism structure of FIG. 1;

FIG. 8 is a schematic diagram of an import channel of FIG. 7 in an open state;

FIG. 9 is a schematic diagram of a structure of a connecting rod of FIG. 1;

FIG. 10 is a schematic diagram of a section view structure of FIG. 9;

FIG. 11 is a schematic diagram of a structure of an air return piston of FIG. 1;

FIG. 12 is a schematic diagram of a section view structure of FIG. 11;

FIG. 13 is a schematic diagram of a structure of a liquid inlet piston of FIG. 1;

FIG. 14 is a schematic diagram of a section view structure of FIG. 13; and

FIG. 15 is a schematic diagram of a section view structure of a tubular spring of FIG. 1.

Reference numerals on the drawings are described below:
10 denotes a main body;
11 denotes a guide hole;
12 denotes a pressing cavity;
13 denotes a bottling cavity;
20 denotes a pressing head;
21 denotes a liquid outlet channel;
30 denotes a barrel body;
31 denotes a liquid outlet channel;
32 denotes an air vent;
33 denotes a flange;
40 denotes a one-way liquid outlet mechanism;
41 denotes an import channel;
42 denotes an export channel;
43 denotes a connecting rod;
431 denotes an ejector rod;
432 denotes guide ribs;
433 denotes a limiting wall;
44 denotes a piston unit;
45 denotes an air return piston;
451 denotes an air plug through hole;
452 denotes guide wall;
46 denotes a liquid inlet piston;
461 denotes liquid plug through holes;
462 denotes a fixing groove;
47 denotes a limiting slot;
50 denotes a tubular spring;
51 denotes a one-way valve;
511 denotes connecting ribs;
512 denotes an elastic membrane;
60 denotes a liquid storage bottle;
70 denotes a gasket; and
80 denotes a suction tube.

### DETAILED DESCRIPTION

The technical solutions in the implementations disclosed herein will be clearly and completely described below with reference to the accompanying drawings in the implementations of the present disclosure.

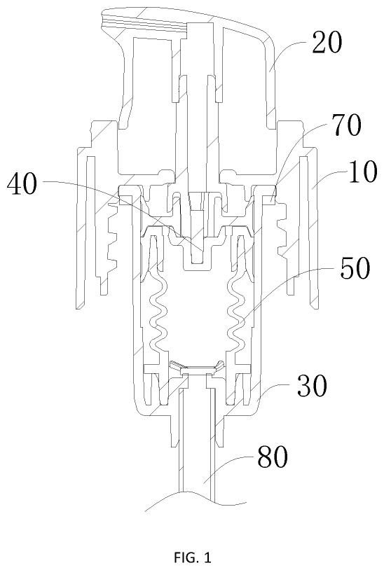

The present disclosure provides a single-material all-plastic lotion pump, the embodiments of which are shown in FIGS. 1 to 8; the single-material all-plastic lotion pump includes a main body 10, a pressing head 20, a barrel body 30, a one-way liquid outlet mechanism 40 and a tubular spring 50 which are made of the same plastic material; the inside of the main body 10 is provided with a guide hole 11, and the guide hole 11 communicates through two opposite ports of the main body 10; the press head 20 is in an inserted connection with one port of the main body 10 in a pressable manner, and the press head 20 is provided with a liquid outlet channel 21; the barrel body 30 is in an inserted connection with the other port of the main body 10, the guide hole 11 is externally surrounded by the barrel body 30, and a bottom wall of the barrel body 30 is provided with a liquid inlet channel 31; the one-way liquid outlet mechanism 40 passes through the guide hole 11, and the one-way liquid outlet mechanism 40 is provided with an import channel 41 and an export channel 42, and the export channel 42 is connected and communicated with the liquid outlet channel 21; the one-way liquid outlet mechanism 40 is used to communicate the import channel 41 and the export channel 42 when the pressing head 20 is pressed; and the tubular spring 50 is compressed between the one-way liquid outlet mechanism 40 and the bottom wall of the barrel body 30, one end of the tubular spring 50 is connected and communicated with the import channel 41, and the other end of the tubular spring 50 is connected and communicated with the liquid inlet channel 31.

During application, the single-material all-plastic lotion pump will be assembled with a liquid storage bottle 60 for use, so by pressing the pressing head 20, the tubular spring 50 will be switched into a compression state or an extension state, resulting in the formation of an air pressure difference in the tubular spring 50; and therefore, lotion in the liquid storage bottle 60 is sucked into the tubular spring 50 through the liquid inlet channel 31.

The one-way liquid outlet mechanism 40 will be driven for linkage by pressing the pressing head 20 to realize the switching of the import channel 41 and the export channel 42 from off to on, so that after the import channel 41 is communicated with the export channel 42, the lotion in the tubular spring 50 can flow through the import channel 41, the export channel 42 and the liquid outlet channel in sequence, and the output of the lotion is further realized.

It should be pointed out that since the embodiment includes the main body 10, the pressing head 20, the barrel body 30, the one-way liquid outlet mechanism 40 and the tubular spring 50 which are made of the same plastic material, the entire lotion pump is made of the same material, and material classification is not required during recycling, which greatly reduces recycling difficulty and recycling cost, and further effectively solves the problem of difficulty in classifying and recycling the existing lotion pumps.

In order to ensure products to be high in strength, simple in processing and easy to recycle, the embodiment preferably sets the single-material all-plastic lotion pump made of polyethylene; the polyethylene (PE) is a thermoplastic resin obtained by polymerization of ethylene. In industry, it also includes a copolymer of ethylene and a small amount of α-olefin; and the polyethylene is odorless, non-toxic, and feels like wax. The polyethylene has excellent low temperature resistance (the minimum service temperature can reach −100° C. to −70° C.), is good in chemical stability, can resist most acid and alkali corrosion (not resistant to oxidizing acid), is insoluble in general solvents at normal temperature, and has low water absorption and excellent electrical insulation.

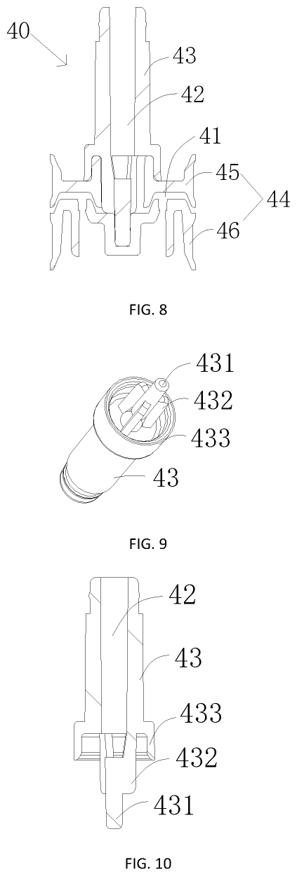

As shown in FIG. 1 and FIGS. 7 to 10, the one-way liquid outlet mechanism 40 includes a connecting rod 43 and a piston unit 44; the connecting rod 43 passes through the guide hole 11, the connecting rod 43 is internally provided with the export channel 42, and the export channel 42 running through both ends of the connecting rod 43; and the piston unit 44 is slidably installed in the barrel body 30, the piston unit 44 is connected to the connecting rod 43, and the import channel 41 is provided on the piston unit 44.

During application, the piston unit 44 can move back and forth in a straight line in the barrel body 30, so when the pressing head 20 is pressed, the pressing head 20 will drive the connecting rod 43 and the piston unit 44 to move downward together, and the compression operation of the tubular spring 50 is accordingly realized; after stopping the pressing of the pressing head 20, the tubular spring 50 will push the piston unit 44 and the connecting rod 43 to move up together with the pressing due to the recovery of deformation; and therefore, due to adoption of the above structure, linkage control between the pressing head 20 and the tubular spring 50 is realized.

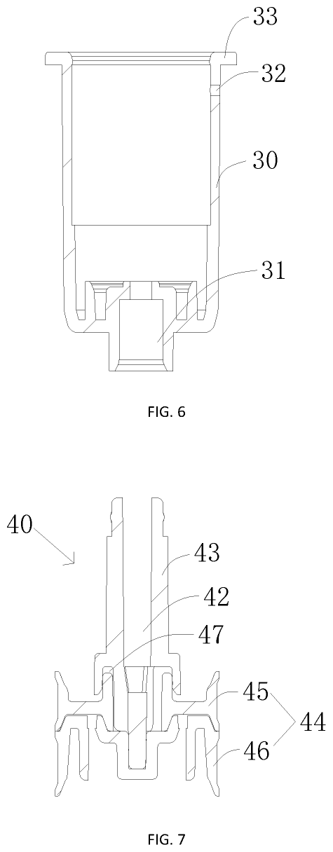

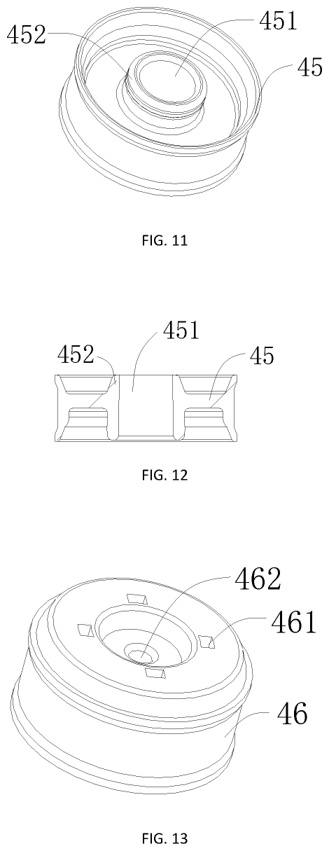

As shown in FIG. 1, FIGS. 6 to 8, and FIGS. 11 to 14, an air vent 32 is reserved in a peripheral wall, adjacent to the guide hole 11, of the barrel body 30, and the air vent 32 is communicated with the inside of the barrel body 30; the piston unit 44 includes an air return piston 45 and a liquid inlet piston 46; the air return piston 45 is slidably installed in the barrel body 30, and the air return piston 45 is provided with an air plug through hole 451 communicating itself; the liquid inlet piston 46 is slidably installed between the air return piston 45 and the tubular spring 50, and the liquid inlet piston 46 is in a sleeved connection with the tubular spring 50; the liquid inlet piston 46 is provided with liquid plug through holes 461 communicating itself, and the plurality of liquid plug through holes 461 are all communicated with the inside of the tubular spring 50; and the connecting rod 43 is connected and fixed with the liquid inlet piston 46 through the air plug through hole 451, the connecting rod 43, the air return piston 45 and the liquid inlet piston 46 are linked by a linkage structure, the air return piston 45 and the liquid inlet piston 46 are controlled to be separated from and abutted against each other by the movement of the connecting rod 43, and the separation between the air return piston 45 and the liquid inlet piston 46 is used to form the import channel 41.

When the pressing head 20 is pressed, the connecting rod 43 will move to the inside of the barrel body 30, and then the movement of the connecting rod 43 will drive the air return piston 45 and the liquid inlet piston 46 to separate from each other, so that an interstice between the air return piston 45 and the liquid inlet piston 46 is utilized to form the import channel 41, and thus the lotion in the tubular spring 50 can flow through the liquid plug through holes 461, the import channel 41, the export channel 42 and the liquid outlet channel 21 in sequence and is then output.

When the pressing of the pressing head 20 is stopped, the connecting rod 43 will move in a direction of moving away from the barrel body 30, and then the movement of the connecting rod 43 will drive the air return piston 45 and the liquid inlet piston 46 to be abutted against each other, so as to close the import channel 41, thereby realizing the sealed preservation of the lotion.

It should be pointed out that after the air return piston 45 moves to the bottom wall of the barrel body 30, the air vent 32 will not be blocked by the air return piston 45, so that the air vent 32 can realize the pressure difference adjustment inside the barrel body 30 to ensure that the tubular spring 50 can be restored to an initial state smoothly.

As shown in FIGS. 7 to 14, the air return piston 45 is provided with a circle of guide wall 452 around a peripheral side of the air plug through hole 451; the liquid inlet piston 46 is provided with a fixing groove 462, and the plurality of liquid plug through holes 461 are provided around a peripheral side of the fixing groove 462; an ejector rod 431, guide ribs 432 and a circle of limiting wall 433 are disposed at one end, placed in the barrel body 30, of the connecting rod 43; the ejector rod 431 is separately disposed opposite to a port of the export channel 42, the ejector rod 431 is inserted into the fixing groove 462 through the air plug through hole 451, and the ejector rod 431 is connected and fixed with the fixing groove 462; the plurality of guide ribs 432 are separately disposed around a peripheral side of the ejector rod 431, and the plurality of guide ribs 432 are all connected between a peripheral edge of the port of the export channel 42 and a peripheral wall of the ejector rod 431; and peripheral sides of the plurality of guide ribs 432 are externally surrounded by the limiting wall 433, a limiting slot 47 is defined by the limiting wall 433 and the plurality of guide ribs 432, and the guide wall 452 is inserted into the limiting slot 47.

When the pressing head 20 is pressed, the connecting rod 43 will move to the inside of the barrel body 30, so that the connecting rod 43 will be capable of driving the liquid inlet piston 46 to move towards a bottom of the barrel body 30, which realizes the separation between the liquid inlet piston 46 and the air return piston 45, that is, the import channel 41 is opened; and as the connecting rod 43 moves to the inside of the barrel body 30, the guide wall 452 will be eventually abutted against a bottom wall of the limiting slot 47, that is, the movement of the connecting rod 43 will also realize the synchronous movement of the air return piston 45, and the air return piston 45 and the liquid inlet piston 46 will continue to move to the inside of the barrel body 30 while remaining separated, thus ensuring that the lotion can continue to flow through the import channel 41 for delivery.

When the pressing of the pressing head 20 is stopped, the connecting rod 43 will move in a direction of moving away from the barrel body 30, so that the connecting rod 43 will pull the liquid inlet piston 46 to move towards the air return piston 45 until the liquid inlet piston 46 and the air return pistons 45 are abutted against each other, and the synchronous movement of the liquid inlet piston 46 and the air return piston 45 is accordingly realized; and since the air return piston 45 and the liquid inlet piston 46 will continue to move away from the bottom wall of the barrel body 30 while remaining abutted against each other, the import channel 41 is ensured to be closed, and the lotion is prevented from flowing out when the pressing head 20 is not pressed.

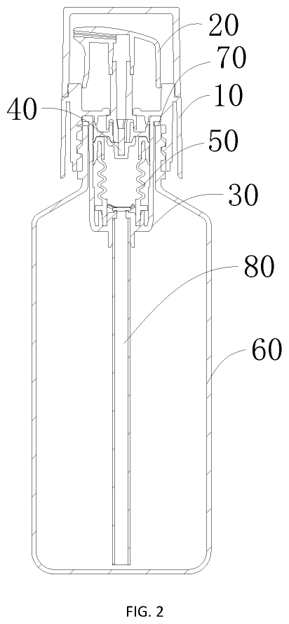

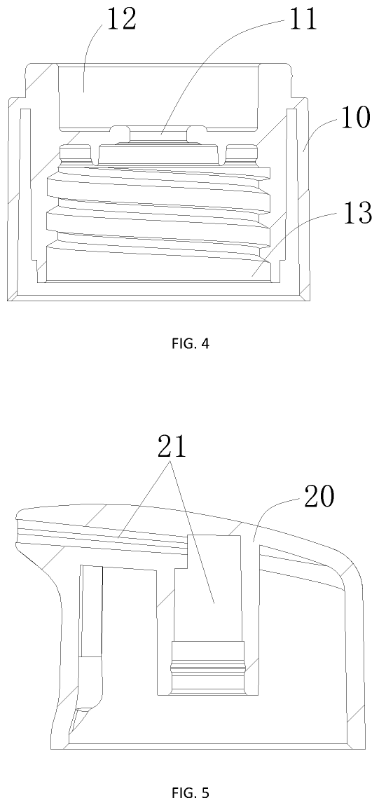

As shown in FIG. 1, FIG. 2 and FIG. 4, the main body 10 is internally provided with a pressing cavity 12 and a bottling cavity 13, the pressing cavity 12 and the bottling cavity 13 are disposed separately with each other, and the pressing cavity 12 and the bottling cavity 13 are allowed to be communicated with each other by the guide hole 11; the pressing cavity 12 is in an inserted connection with the pressing head 20; and the bottling cavity 13 is in an inserted connection with the barrel body 30, an inner peripheral wall of the bottling cavity 13 is separated from an outer peripheral wall of the barrel body 30, and the inner peripheral wall of the bottling cavity 13 is provided with internal threads.

For example, an opening portion of the pressing cavity 12 can be designed to be narrowed inward, and a lower portion of the pressing head 20 can be designed to be expanded outward, so that after the pressing head 20 is inserted into the pressing cavity 12, a limit buckling structure can be formed between the pressing head 20 and the pressing cavity 12 so as to prevent the pressing head 20 from escaping from the pressing cavity 12.

However, the interstice between the bottling cavity 13 and the barrel body 30 can be used to install the liquid storage bottle 60. For example, a port of the liquid storage bottle 60 can be provided with external threads, and the liquid storage bottle 60 can be in a threaded connection with an inner peripheral wall of the bottling cavity 13, so that the installation and fixation between the lotion pump and the liquid storage bottle 60 can be realized.

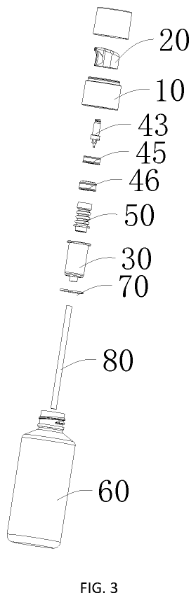

As shown in FIG. 1, FIG. 2, FIG. 3, FIG. 4 and FIG. 6, an outer peripheral edge, facing a port of the guide hole 11, of the barrel body 30 is provided with a circle of flange 33, the flange 33 is abutted against a cavity bottom of the bottling cavity 13; and the single-material all-plastic lotion pump further includes a gasket 70, the gasket 70 is sleeved outside the barrel body 30 and the gasket 70 is abutted against with the flange 33.

Due to the arrangement, if the lotion pump and the liquid storage bottle 60 are installed and fixed, the gasket 70 will be placed between the port of the liquid storage bottle 60 and the flange 33, so that the gasket 70 is utilized to strengthen the installation tightness between the lotion pump and the liquid storage bottle 60.

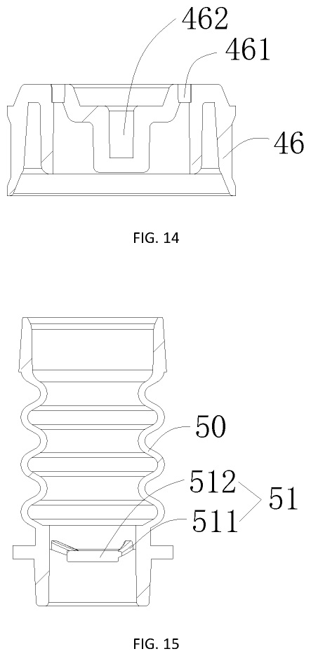

As shown in FIG. 1, FIG. 6 and FIG. 15, the tubular spring 50 is provided with a one-way valve 51, the one-way valve 51 covers the liquid inlet channel 31 and the one-way valve 51 is used to control the liquid inlet channel 31 to feed liquid into the tubular spring 50 in a one-way manner.

After the one-way valve 51 is additionally disposed, the one-way valve 51 only allows the lotion to be input into the tubular spring 50, and prevents the lotion inside the tubular spring 50 from returning to the liquid storage bottle 60, thereby ensuring the smoothness of the operation for a user.

As shown in FIG. 1, FIG. 6 and FIG. 15, the one-way valve 51 includes connecting ribs 511 and an elastic membrane 512; one ends of the plurality of connecting ribs 511 are all connected with an inner peripheral wall of the tubular spring 50, and the other ends of the plurality of connecting ribs 511 are all connected with a peripheral edge of the elastic membrane 512; and the elastic membrane 512 covers the liquid inlet channel 31, and the elastic membrane 512 is used to deform under a force so as to release the covering to the liquid inlet channel 31.

For example, when internal and external pressure differences of the tubular spring 50 are balanced or the tubular spring 50 is compressed, the one-way valve 51 will cover the liquid inlet channel 31, thereby preventing the lotion in the tubular spring 50 from returning to the liquid storage bottle 60; when the tubular spring 50 recovers to stretch due to the change of the pressure difference, a suction force will be formed by the change of the pressure difference, thereby pulling the elastic membrane 512 to bend and deform in a direction of the pressing head 20; and therefore, the elastic membrane 512 releases the covering to the liquid inlet channel 31 and thus realizes the delivery of the lotion into the tubular spring 50.

As shown in FIGS. 1 to 3, the single-material all-plastic lotion pump further includes a suction tube 80, the suction tube 80 is disposed outside the barrel body 30 and the suction tube 80 is communicated with the liquid inlet channel 31.

Due to the arrangement of the suction tube 80, the available suction tube 80 is extended to a bottom of the liquid storage bottle 60, thereby ensuring that the lotion can be more fully sucked out.

The above mentioned is the preferred implementation of the present disclosure. It should be pointed out that for those skilled in the art, many other improvements or modifications can be made without departing from the principle of the present disclosure, and these improvements and modifications are also recognized as the protection scope of the present disclosure.

What is claimed is:

1. A single-material all-plastic lotion pump, comprising:
a main body, a pressing head, a barrel body, a one-way liquid outlet mechanism and a tubular spring which are made of the same plastic material;
the inside of the main body is provided with a guide hole communicating through two opposite ports of the main body;
the press head is in an inserted connection with one port of the main body in a pressable manner, and is provided with a liquid outlet channel;
the barrel body is in an inserted connection with the other port of the main body, the guide hole is externally surrounded by the barrel body, and a bottom wall of the barrel body is provided with a liquid inlet channel;
the one-way liquid outlet mechanism passes through the guide hole, and is provided with an import channel and an export channel, and the export channel is connected and communicated with the liquid outlet channel; the one-way liquid outlet mechanism is used to communicate the import channel and the export channel when the pressing head is pressed; and
the tubular spring is compressed between the one-way liquid outlet mechanism and the bottom wall of the barrel body, one end of the tubular spring is connected and communicated with the import channel, and the other end thereof is connected and communicated with the liquid inlet channel.

2. The single-material all-plastic lotion pump according to claim 1, wherein the single-material all-plastic lotion pump is made of polyethylene.

3. The single-material all-plastic lotion pump according to claim 1, wherein
the one-way liquid outlet mechanism comprises a connecting rod and a piston unit;
the connecting rod passes through the guide hole, and is internally provided with the export channel running through both ends of the connecting rod; and
the piston unit is slidably installed in the barrel body, the piston unit is connected to the connecting rod, and the import channel is provided on the piston unit.

4. The single-material all-plastic lotion pump according to claim 3, wherein
an air vent is reserved in a peripheral wall, adjacent to the guide hole, of the barrel body, and is communicated with the inside of the barrel body;
the piston unit comprises an air return piston and a liquid inlet piston;
the air return piston is slidably installed in the barrel body, and is provided with an air plug through hole communicating itself;
the liquid inlet piston is slidably installed between the air return piston and the tubular spring, and the liquid inlet piston is in a sleeved connection with the tubular spring; the liquid inlet piston is provided with liquid plug through holes communicating itself, and the plurality of liquid plug through holes are all communicated with the inside of the tubular spring; and
the connecting rod is connected and fixed with the liquid inlet piston through the air plug through hole, the connecting rod, the air return piston and the liquid inlet piston are linked by a linkage structure, the air return piston and the liquid inlet piston are controlled to be separated from and abutted against each other by the movement of the connecting rod, and the separation between the air return piston and the liquid inlet piston is used to form the import channel.

5. The single-material all-plastic lotion pump according to claim 4, wherein
the air return piston is provided with a circle of guide wall around a peripheral side of the air plug through hole;
the liquid inlet piston is provided with a fixing groove, and the plurality of liquid plug through holes are provided around a peripheral side of the fixing groove;
an ejector rod, guide ribs and a circle of limiting wall are disposed at one end, placed in the barrel body, of the connecting rod;
the ejector rod is separately disposed opposite to a port of the export channel, the ejector rod is inserted into the fixing groove through the air plug through hole, and the ejector rod is connected and fixed with the fixing groove;
the plurality of guide ribs are separately disposed around a peripheral side of the ejector rod, and are all connected between a peripheral edge of the port of the export channel and a peripheral wall of the ejector rod; and
peripheral sides of the plurality of guide ribs are externally surrounded by the limiting wall, a limiting slot is defined by the limiting wall and the plurality of guide ribs, and the guide wall is inserted into the limiting slot.

6. The single-material all-plastic lotion pump according to claim 1, wherein
the main body is internally provided with a pressing cavity and a bottling cavity, and the pressing cavity and the bottling cavity are disposed separately and are allowed to be communicated with each other by the guide hole;
the pressing cavity is in an inserted connection with the pressing head; and
the bottling cavity is in an inserted connection with the barrel body, an inner peripheral wall of the bottling cavity is separated from an outer peripheral wall of the barrel body, and the inner peripheral wall of the bottling cavity is provided with internal threads.

7. The single-material all-plastic lotion pump according to claim 6, wherein
an outer peripheral edge, facing a port of the guide hole, of the barrel body is provided with a circle of flange, which is abutted against a cavity bottom of the bottling cavity; and
the single-material all-plastic lotion pump further comprises a gasket, and the gasket is sleeved outside the barrel body and is abutted against with the flange.

8. The single-material all-plastic lotion pump according to claim 1, wherein the tubular spring is provided with a one-way valve, and the one-way valve covers the liquid inlet channel and is used to control the liquid inlet channel to feed liquid into the tubular spring in a one-way manner.

9. The single-material all-plastic lotion pump according to claim 8, wherein
the one-way valve comprises connecting ribs and an elastic membrane;
one ends of the plurality of connecting ribs are all connected with an inner peripheral wall of the tubular spring, and the other ends thereof are all connected with a peripheral edge of the elastic membrane; and
the elastic membrane covers the liquid inlet channel, and is used to deform under a force so as to release the covering to the liquid inlet channel.

10. The single-material all-plastic lotion pump according to claim 1, wherein the single-material all-plastic lotion pump further comprises a suction tube, and the suction tube is disposed outside the barrel body and is communicated with the liquid inlet channel.
